(19) United States
(12) Patent Application Publication
(10) Pub. No.: US 2004/0059788 A1
(43) Pub. Date: Mar. 25, 2004

(54) Dissemination of computer executable program files in a digital communiation network

(76) Inventor: Avron Marcus, London (GB)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 10/466,987

(22) PCT Filed: Jan. 22, 2002
(86) PCT No.: PCT/IB02/00165

(30) Foreign Application Priority Data
Jan. 24, 2001 (GB) 0101869.6

(51) Int. Cl. G06F 15/16

(52) U.S. Cl. 709/206; 709/217

(57) ABSTRACT

A system for disseminating executable program files on a digital communication network, comprises: a sending workstation operable by a sender to transmit a message to an intended recipient along the digital communication network; a receiving workstation operable by a recipient to receive the message from the sender along the digital communication network; a repository of display frames, each display frame containing at least one executable program; insertion means associated with the sending workstation for inserting a command code into the message to be transmitted to the recipient by the sender; and detection means associated with the receiving workstation, the detection means being responsive to reading of the received message by the recipient to detect the command code in the received message and to load from the repository of executable program files at least one display frame corresponding to the detected command code. The invention extends to a method for disseminating executable program files on a digital communication network.

### FIELD OF THE INVENTION

This invention relates to a system for the dissemination of executable program files on a digital communication network and, more particularly, to a system for the dissemination of executable program files by means of a messaging system. The invention extends to a method of disseminating executable programs on a digital communication network.

### BACKGROUND TO THE INVENTION

The advent of open communication networks such as the Internet has provided a new medium for the dissemination of promotional material. It is well known for Internet websites which are popular and widely visited by Internet users to be sought after by advertisers who wish to place promotional material such as advertisement “banners” on such websites in order to be visible to visitors to the websites.

An Internet banner advertisement may be activated by a visitor to the website by clicking thereon, thereby drawing related promotional material from a remote web server for display at the visitor's workstation. Such an operation is referred to as a “click-through”. Click-through operations are valuable for advertisers as they constitute evidence that a potential consumer of the advertiser's goods or services has seen their promotional material.

It is also known to include references to Internet banner advertisements in e-mail messages. When a recipient thereof views such an e-mail message, the relevant Internet banner advertisement is displayed to the recipient of the message to await a potential click-through operation.

A disadvantage of such click-through operations is that they rely on a positive act by a viewer in order to display information related to the banner. Many factors, such as slow download speeds caused by bandwidth limitations, and nuisance value constitute disincentives which discourage users from effecting click-through operations.

In order to overcome this disadvantage, it is known to include the code of an Internet web page as part of an e-mail message, such that the web page is automatically displayed when a recipient thereof views the e-mail. The problem with this type of e-mail dissemination of web pages is that, as far as the applicant is aware, it is not possible to include executable code as part of the e-mail message, without significantly increasing the size of the e-mail message. It is also not possible to automatically load the executable code on the recipient's workstation when the e-mail message is viewed.

### OBJECT OF THE INVENTION

It is an object of this invention to provide a system for disseminating executable program files on a digital communication network and a method of disseminating executable programs on a digital communication network which will, at least partially, alleviate the abovementioned difficulties and disadvantages.

### SUMMARY OF THE INVENTION

In accordance with this invention there is provided a system for disseminating executable program files on a digital communication network, comprising:

a sending workstation operable by a sender to transmit a message to an intended recipient along the digital communication network;

a receiving workstation operable by a recipient to receive the message from the sender along the digital communication network;

a repository of display frames, each display frame containing at least one executable program;

insertion means associated with the sending workstation for inserting a command code into the message to be transmitted to the recipient by the sender; and

detection means associated with the receiving workstation, the detection means being responsive to reading of the received message by the recipient to detect the command code in the received message and to load from the repository of executable program files at least one display frame corresponding to the detected command code.

Further features of the invention provide for the message transmitted by the sender to the intended recipient to be an e-mail message, for the digital communication network to be an open communication network, for the open communication network to be the Internet, and for the at least one executable program file to be any one of a Flash, Front Page, Dream Weaver or a Java executable program file.

Still further features of the invention provide for the insertion means to be an application program loadable and executable on the sending workstation, for the detection means to be an e-mail application program which is loadable and executable on the receiving workstation, for the command code in the e-mail message transmitted by the sender to the intended recipient to be interpretable code, for the interpretable code to be Hypertext Mark-up Language (HTML) code, and for the detection means to load the at least one display frame corresponding to the detected command code by means of an Internet web browser program.

Yet further features of the invention provide for the system to include a register of a plurality of intended recipients of the message, for the sending workstation to transmit a message to each one of the intended recipients contained in the register, and for the message transmitted to each one of the intended recipients to be customized for each recipient.

The invention extends to a method for disseminating executable program files on a digital communication network, comprising the steps of:

inserting a command code into a message to be transmitted by a sender to an intended recipient;

transmitting the message to the intended recipient along the digital communication network;

receiving the message from the sender along the digital communication network;

detecting the command code in the received message; and

loading, from a repository of display frames, at least one display frame corresponding to the detected command code, each of the display frames in the repository containing at least one executable program file.

There is further provided for inserting the command code into the message by means of an application program loadable and executable on a sending workstation, for detecting the command code in the received message by means of an e-mail application program which is loaded and executing on a receiving workstation, for transmitting the command code in the e-mail message from the sender to the intended recipient as interpretable code, for the interpretable code to be Hypertext Mark-up Language (HTML) code, and for the loading the at least one display frame corresponding to the detected command code by means of an Internet web browser program.

There is still further provided for establishing a register of a plurality of intended recipients of the message, for transmitting a message from the sender to each one of the intended recipients contained in the register, and for customizing the message transmitted to each one of the intended recipients contained in the register.

### BRIEF DESCRIPTION OF THE DRAWINGS

One embodiment of the invention is described below, by way of example only, and with reference to the accompanying drawings, in which:

FIG. 1 is a functional block diagram of a system for disseminating executable program files, according to the invention

### DETAILED DESCRIPTION OF THE DRAWINGS

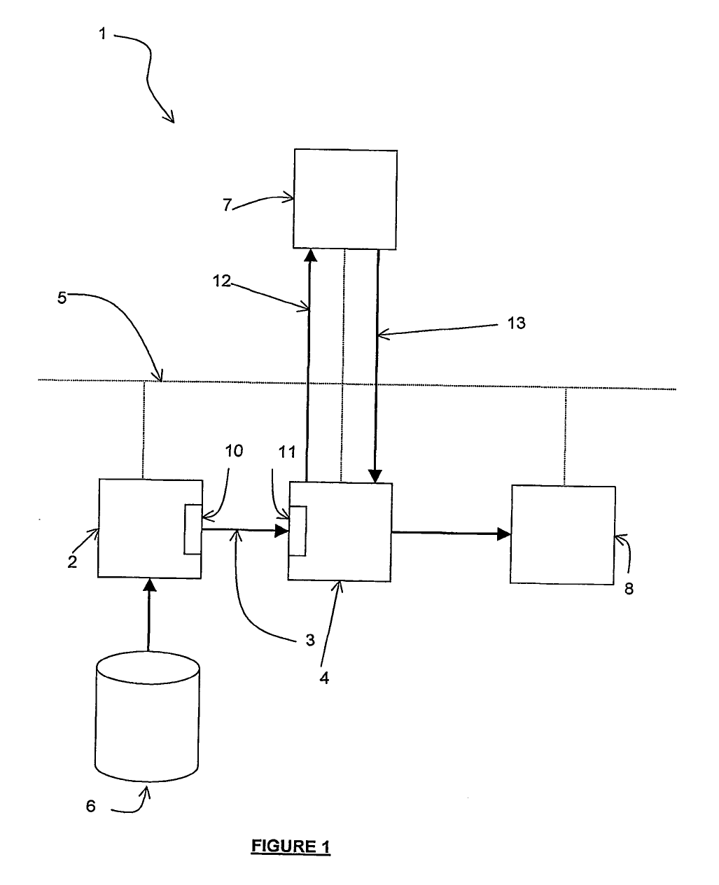

Referring to FIG. 1, a system for the dissemination of executable program files is indicted generally by reference numeral (1).

The system (1) includes a sending workstation (2) operable by a sender to transmit an e-mail message (3) conforming to the well-known mail transport protocol Simple Mail Transfer Protocol (SMTP), to an intended recipient at a receiving workstation (4). The sending workstation (2) and the receiving workstation (4) are connected to an open digital communication network in the form of the Internet (5).

For convenience, the communication network (5) is shown in dotted lines in FIG. 1, while the different messages transmitted along the digital communication network (5) are represented by arrows.

The system (1) also includes a register (6) of intended recipients of a message from the sending workstation (2). The register (6) of intended recipients is an address database which is stored locally on the sending workstation (2). The system (1) also contains a display facility (8) at the receiving workstation (4).

The sending workstation (2) includes insertion means (10) in the form of an application program which is loadable and executable on the sending workstation. The application program (10) detects outgoing SMTP messages (3) which are transmitted from the sending workstation (2). Under the well-known Windows suite of operating systems available from Microsoft Incorporated of Seattle, Wash., SMTP messages are usually transmitted to port 25 of an e-mail server (not shown) via the Internet. When an outgoing SMTP message (3) is detected in this manner, a command code in the form of a Hypertext Mark-Up Language (HTML) code is inserted into the outgoing SMTP e-mail message, the operation of which will be described below.

When the transmitted SMTP e-mail message (3) is received at the receiving workstation (4), the message is processed by a detection means (11) in the form of an e-mail application program, and the HTML code contained in the e-mail message is interpreted to cause the receiving workstation (4) to transmit a Hypertext Transfer Protocol (HTTP) request message (12) to an Internet web server (7) whose URL is contained in the HTML code. Processing of the email message (3) by the e-mail application program also causes an Internet browser program to be launched on the receiving workstation (4).

Upon receiving the request message, the Internet web server (7) accesses a repository (not shown) of display frames to obtain therefrom a display frame corresponding to the HTML code contained in the e-mail message (3). Each display frame in the repository contains one or more executable programs. In this embodiment the executable programs are written in the well-known Micromedia Flash application programming language, which is compatible with various Internet web browser programs. The Internet web server (7) then transmits a response message (13) containing the display frame corresponding to the HTML code contained in the e-mail message (3) back to the receiving workstation (4). The display frame contained in the response message (13) is displayed by the Internet browser program on the display facility (8) as a window in the e-mail application program.

It will be appreciated by those skilled in the art that the system (1) allows executable program files to be transmitted to an intended recipient at a receiving workstation (4) and displayed to the recipient without requiring a click-through operation to be carried out by the recipient. This is advantageous to advertisers or service providers whose commercial success is directly dependent on the number of recipients who use the executable program files contained in the display frame. Examples of such executable program files are financial calculators and on-line casino games. It is anticipated that dissemination of executable program files in this manner will significantly reduce the chances of recipient “drop-out”.

The insertion means (10) may be programmed to send an e-mail message to each one of the intended recipients in the registry (6). The same e-mail message may be sent to each one of the intended recipients, or the message sent to each intended recipient may be individually customized. This use of the system (1) will simplify the execution of large-scale dissemination of executable program files.

Numerous modifications are possible to this embodiment without departing from the scope of the invention. In particular, the communication network (5) may be a closed communication network, or an open communication network other than the Internet. Further, the operating system used in the sending (2) and receiving (4) workstations may be an operating system outside of the Windows family of operating systems. Still further or the register (6) of intended recipients of an e-mail message may be made accessible through an Internet web server (not shown), instead of being stored locally at the sending workstation (2). Yet further, the executable program files may be written in any one of the well-known Front Page, Dream Weaver or Java programming languages instead of the Macromedia Flash programming language.

The invention therefore provides a system and a method for disseminating executable program files by means of e-mail which increases the likelihood of e-mail recipients electing to run the executable program files.

1. A system for disseminating executable program files on a digital communication network, comprising:
a sending workstation operable by a sender to transmit a message to an intended recipient along the digital communication network;
a receiving workstation operable by a recipient to receive the message from the sender along the digital communication network;
a repository of display frames, each display frame containing at least one executable program;
insertion means associated with the sending workstation for inserting a command code into the message to be transmitted to the recipient by the sender; and
detection means associated with the receiving workstation, the detection means being responsive to reading of the received message by the recipient to detect the command code in the received message and to load from the repository of executable program files at least one display frame corresponding to the detected command code.

2. A system as claimed in claim 1 in which the message transmitted by the sender to the intended recipient is an e-mail message.

3. A system as claimed in either one of claims 1 or 2 in which the digital communication network is an open communication network.

4. A system as claimed in claim 3 in which the open communication network is the Internet.

5. A system as claimed in any one of the preceding claims in which the at least one executable program file is any one of a Flash, Front Page, Dream Weaver or a Java executable program file.

6. A system as claimed in any one of the preceding claims in which the insertion means is an application program loadable and executable on the sending workstation.

7. A system as claimed in any one of the preceding claims in which the detection means is an e-mail application program which is loadable and executable on the receiving workstation.

8. A system as claimed in any one of the preceding claims in which the command code in the e-mail message transmitted by the sender to the intended recipient is interpretable code.

9. A system as claimed in claim 8 in which the interpretable code is be Hypertext Mark-up Language (HTML) code.

10. A system as claimed in either one of claims 8 or 9 in which the detection means loads the at least one display frame corresponding to the detected command code by means of an Internet web browser program.

11. A system as claimed in any one of the preceding claims which includes a register of a plurality of intended recipients of the message.

12. A system as claimed in claim 11 in which the sending workstation transmits a message to each one of the intended recipients contained in the register.

13. A system as claimed in claim 12 in which the message transmitted to each one of the intended recipients is customized for each recipient.

14. A method for disseminating executable program files on a digital communication network, comprising the steps of:
inserting a command code into a message to be transmitted by a sender to an intended recipient;
transmitting the message to the intended recipient along the digital communication network;
receiving the message from the sender along the digital communication network;
detecting the command code in the received message; and
loading, from a repository of display frames, at least one display frame corresponding to the detected command code, each of the display frames in the repository containing at least one executable program file.

15. A method as claimed in claim 14 in which the command code is inserted into the message by means of an application program loadable and executable on a sending workstation.

16. A method as claimed in either one of claims 14 or 15 in which the command code in the received message is detected by means of an email application program which is loaded and executing on a receiving workstation.

17. A method as claimed in any one of claims 14 to 17 in which the command code in the e-mail message from the sender to the intended recipient is transmitted as interpretable code.

18. A method as claimed in claim 17 in which the interpretable code is Hypertext Mark-up Language (HTML) code.

19. A method as claimed in any one of claims 14 to 18, which includes the step of loading the at least one display frame corresponding to the detected command code by means of an Internet web browser program.

20. A method as claimed in any one of claims 14 to 19 which includes the step of establishing a register of a plurality of intended recipients of the message.

21. A method as claimed in claim 20 in which a message is transmitted from the sender to each one of the intended recipients contained in the register.

22. A method as claimed in claim 21 in which the message transmitted to each one of the intended recipients contained in the register is customized for each one of the intended recipients.

23. A system for disseminating executable program files on a digital communication network, substantially as described and illustrated herein with reference to the accompanying diagrammatic drawing.

24. A method, substantially as herein described with reference to the accompanying diagrammatic drawing, for disseminating executable program files on a digital communication network.
